(19) United States
(12) Patent Application Publication
(10) Pub. No.: US 2007/0240282 A1
(43) Pub. Date: Oct. 18, 2007

(54) Opening/closing device for document pressing device

(76) Inventor: Yukihiro Nishida, Osaka-hu (JP)

Correspondence Address: NATH & ASSOCIATES, 112 South West Street, Alexandria, VA, 22314, US

(21) Appl. No.: 11/701,552

(22) Filed: Feb. 2, 2007

(30) Foreign Application Priority Data
Mar. 2, 2006 (JP) 2006-000657

(51) Int. Cl. E05D 7/00

(52) U.S. Cl. 16/223

(57) ABSTRACT

A hinge member 3 that is attached to a document pressing plate 2 and includes a tubular supporting leg 5, in which a projection member 7 is incorporated so that a tip 71a of the projection member 7 appears and disappears in an opening part 6, and a spring member 8 for always biasing the projection member so that the tip 71a of the projection member 7 projects from the opening part 6 is also incorporated. Thus, by attaching the tip 71a that projects from the opening part 6 of the projection member 7 to an inner wall surface 4a of the supporting hole 4, the tubular supporting leg 5 of the hinge member 3 can be securely fixed in the supporting hole 4 without jouncing.

### BACKGROUND OF THE INVENTION

1. Field of the Invention

The present invention relates to an opening/closing device for a document pressing plate of a copier, a printer, a scanner, or the like.

2. Description of the Related Art

Conventionally, as an opening/closing device for this kind of document pressing plate, there has been known an image scanning apparatus body 20 (hereinafter referred to as the apparatus body) of which document opening/closing plate 21 is attached to the device body via a hinge member 22, as shown in FIG. 7, so that the plate can be opened and closed in a rotational manner (for example, refer to the Patent Document 1).

The hinge member 22 is attached on the edge side of a rotator and is equipped with a supporting leg 24 that is inserted into a supporting hole 23 provided on an upper surface of the apparatus body 20. As shown in FIG. 7 (a), the hinge member 22 attached to the document pressing plate 21 is fixed on the apparatus body 20 as the supporting leg 24 is inserted into the supporting hole 23.

(Patent Document 1) Japanese Unexamined Patent Application No. 2005-260761 (FIG. 4)

However, despite the fact that a clearance C is provided between the supporting leg 24 and inner periphery of the supporting hole 23 to make it easy to insert the supporting leg 24 of the hinge member 22 into the supporting hole 23 on the side of the apparatus body 20, the above described opening/closing device for document pressing plate makes abnormal noises as the supporting legs 24, as shown in FIG. 7 (b), moves to the position where the supporting leg 24 comes in contact with the inner surface of the supporting hole 23 when open/close the document pressing plate 21. Moreover, when a document placed on the apparatus body 20 is pressed by closing the document pressing plate 21, due to the reaction of the pressing force, the supporting leg 24 is pulled up from the supporting hole 23, causing uneven pressing of the document by the document pressing plate 21, resulting in problems in reading out the document.

The present invention has been made to solve such problems. The purpose of the present invention is to provide an opening/closing device for a document pressing plate that is provided with a hinge member as described above, wherein a supporting leg of the hinge member can be securely fixed to a supporting hole on an apparatus body side without jouncing to prevent abnormal noises from occurring when open/close the document pressing plate and to prevent the hinge member from being pulled up when the document pressing plate is closed.

### SUMMARY OF THE INVENTION

To achieve the above mentioned purpose, an opening/closing device for a document pressing plate of the present invention includes, as described in claim 1, a document pressing plate provided to an apparatus body via a hinge member to be enable to open and close in a rotational manner, the hinge member is provided on the edge side of a rotator of the document pressing plate and a tubular supporting leg that is inserted into a supporting hole provided on the upper surface of the apparatus body, wherein an opening part is provided on a peripheral side wall of the tubular supporting leg, a projection member is incorporated into the tubular supporting leg so that the tip of the projection member can appear and disappear in the opening part while a spring member for pressing and biasing the projection member is also incorporated so that the projection member is always being pressed and biased to allow the tip of the projection member being projected from the opening part, and the tip of the projection member that is projected from the opening part is attached to an inner wall surface of the supporting hole.

Thus, allowing the projection member in the tubular supporting leg to freely appear and disappear in the opening part and allowing the projection member to be pressed and biased by a spring member for biasing the projection member so that the tip of the projection member is attached to the inner surface, due to the reaction force of the attachment, the tubular supporting leg is brought to an inner surface that is opposite to the above mentioned inner surface and is fixed so that the supporting leg is not moved in the supporting hole. The tubular supporting leg can be easily inserted into the supporting hole by immersing the tip of the projection member into the opening part resisting the bias of the spring member for biasing the projection member.

The opening/closing device for a document pressing plate described in the claim 1, as described in claim 2, includes the hinge member that has a cam member pivotally connected to the head side of the tubular supporting leg to be able to rotate with a hinge pin as its pivot point, a slider that is stored in the upper part of the projection member and the spring member in the tubular supporting leg that can freely slide upward having a sliding tip that slides along a cam surface of the cam member and a spring member for biasing the slider that always pushes and biases the slider toward the cam member, wherein the cam member, the slider, and the spring member for biasing the slider generates a torque which reacts to the direction of the torque to which the document pressing plate is closed to stop and keep the document pressing plate with a desired opening angle by the balance of the torque.

According to the present invention, the tubular supporting leg of the hinge member is securely fixed without jouncing in the supporting hole thanks to the projection member and the spring member for biasing the projection member, preventing abnormal noises from occurring between the tubular supporting leg and the supporting hole when open/close the document pressing plate. Moreover, the hinge member and the document pressing plate can be prevented from being pulled up when the document pressing plate is closed, ensuring the reading out of the document.

### BRIEF DESCRIPTION OF THE DRAWINGS

FIG. 1 shows an embodiment of the present invention and is a cross-sectional view of an open/close device for a document pressing plate. The document pressing plate is opened and stopped at an angle for intermediate position.

FIG. 2 is a cross-sectional view of the document pressing plate to which a hinge member is attached.

FIG. 3 is an exploded perspective view of the hinge member.

FIG. 4 is a perspective view of a tubular supporting leg, a projection member, a spring member, and a spring receipt plate of the hinge member seen from a different direction.

FIG. 5 is a perspective view of the hinge member after composition.

FIG. 6 is a cross-sectional view of another embodiment of an open/close device for a document pressing plate that corresponds to FIG. 1.

FIG. 7 is a cross-sectional view of a conventional open/close device for a document pressing plate.

### DESCRIPTION OF THE PREFERRED EMBODIMENT

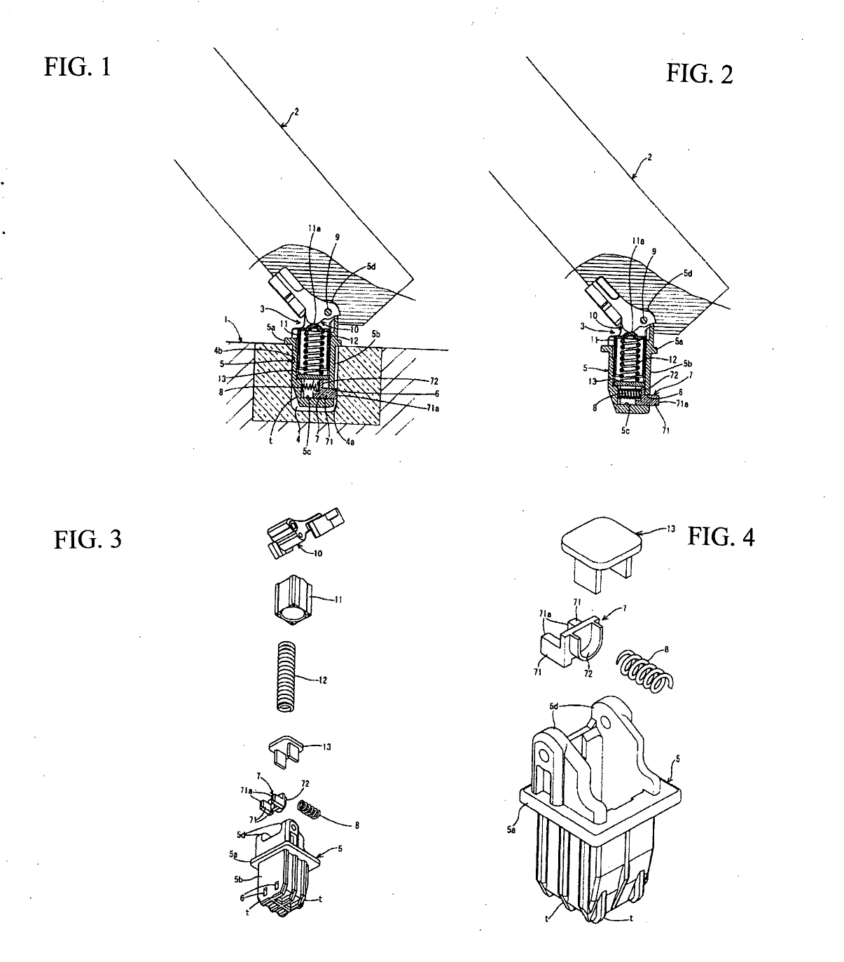

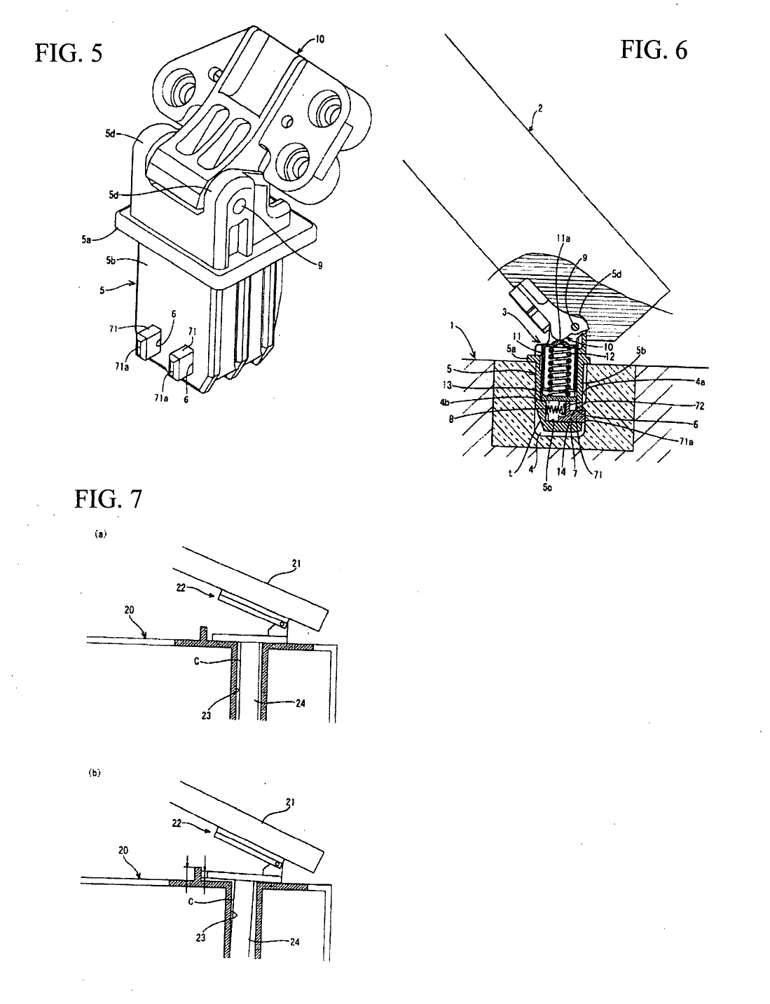

A preferred embodiment of the present invention will be described with reference to the figures. FIGS. 1 to 5 show an embodiment example of the present invention. FIG. 1 is a cross-sectional view of an opening/closing device of a document pressing plate in a condition where the document pressing plate is stopped with an opening angle of an intermediate position, FIG. 2 is a cross-sectional view of the same in a condition where a hinge member is fixed to the document pressing plate, FIG. 3 is an exploded perspective view of the hinge member, FIG. 4 is a perspective view of a tubular supporting leg, a projection member, a spring member, and a spring receipt plate of the hinge member seen from a different direction, and FIG. 5 is a perspective view of the hinge member after composition.

In FIG. 1, the opening/closing device for a document pressing plate of the present invention enables a document pressing plate 2 to be attached on a document placement surface of an apparatus body 1, which is a copier or the like, via a hinge member 3 to allow the document pressing plate 2 to open/close in a rotating manner.

As shown in FIGS. 1 and 2, the hinge member 3 is attached on the base edge side of a rotator while having a tubular supporting leg 5 to be inserted into a supporting hole 4 provided in the apparatus body 1. The supporting hole 4 is formed to be a square when viewed cross-sectionally, having an inner diameter a little larger than the outer diameter of the tubular supporting leg to enable easy insertion of the tubular supporting leg 5.

As shown in FIGS. 3 and 4, the tubular supporting leg 5 is formed for easy insertion into the supporting hole 4 with an upper-opening tubular shape having a bottom, while the lower end thereof is tapered by a taper t. Moreover, the tubular supporting leg 5 is formed to have a guard 5a on the upper-end side of outer diameter of the tubular supporting leg 5 while one or more than two (two in the illustrated example) opening part 6 is provided on the lower part of one side of surrounding wall 5b. Moreover, as shown in FIGS. 1 and 2, in the tubular supporting leg 5, a projection member 7, including a projection 71 corresponding to the opening part 6 and a spring receiving part 72 formed with the projection 71 in a integrated manner at the bottom thereof, is incorporated on an inner bottom surface 5c while freely sliding thereon so that a tip 71a of the projection 71 can appear and disappear in the opening part 6. Furthermore, in the tubular supporting leg 5, a spring member 8 for biasing the projection member which includes a compressed coil spring, a twisted coil spring, a plate spring, a synthetic resin spring, or the like that pushes and biases the projection member 7 so that it is projected from the opening part 5 is also incorporated.

As shown in FIGS. 1 and 2, the hinge member 3 is attached to the edge side of the rotator of the document pressing plate 2 by an attaching screw or the like and includes between a pair of roller bearing 5d and 5d which are provided in the upper part of the tubular supporting leg 5 a cam member 10 which is pivotally connected and is able to rotate around a hinge pin 9, a slider (a cam follower) 11 that is stored and can freely slide up and downwards from the projection part 7 and the spring member 8 in the tubular supporting leg 5 and has a sliding projection 11a that slides along a cam surface of the cam member 10, and a spring member 12 that always biases the slider 11 toward the cam member 10. The cam member 10, the slider 11, and the spring member 12 generate a torque that reacts to a torque toward the direction to which the document pressing plate 2 is closed so that the document pressing plate 2 is opened and stopped with a desired angle by the balance between the torques. Note that in the upper part of the projection member 7 and the spring member 8 in the tubular supporting leg 5, a spring receiving member 13 having a leg is provided. The spring receiving member 13, which functions like a lid, receives the lower end of the spring member 12 for biasing the slider on the upper surface of the spring receipt member 13.

After attaching the hinge member 3 to the edge side of the rotator of the document pressing plate 2 in a manner that is shown in FIG. 2, the tubular supporting leg 5 is inserted into the supporting hole 4 until the guard 5a reaches the upper surface periphery of the opening of the supporting hole 4 as shown in FIG. 1. Thus, the document pressing plate 2 which can open and close in a rotational manner, is fixed to the apparatus body 1. At this time, the tubular supporting leg 5 can be easily inserted in to the supporting hole 4 as a tip 71a of the projection member 7 is immersed in the opening part 6 against bias of the spring member 8. After the insertion, the tip 71a of the projection member 7 projects from the opening part 6 by the bias of the spring member 8 and is attached to an inner wall surface 4a of the supporting hole 4. The reaction to the attachment causes the tubular supporting leg 5 to be pulled to an inner wall surface 4b, which is opposite to the inner wall surface 4a, so that the tubular supporting leg 5 is securely fixed and does not move in the supporting hole 4.

As described above, the opening/closing device for the document pressing plate 2 in which the tubular supporting leg 5 of the hinge member 3 is fixed in the supporting hole 4 via the projection member 7 and the spring member 8 prevents abnormal sounds from occurring between the tubular supporting leg 5 and the supporting hole 4 when open/close the document pressing plate 2 and the also prevents the hinge member 3 and the document pressing plate 2 from being pulled up when the document pressing plate 2 is closed, securing the read out of the document.

As shown in FIG. 6, a convex part 14 can be provided on the inner wall surface 4a of the supporting hole 4 to attach the tip 71a of the projection member 7 that projects from the opening part 6 when the tubular supporting leg 5 is inserted into the supporting hole 4. With this structure, the tip 71a of the projection member 7 slides along the convex part 14 when the tubular supporting leg 5 is inserted to be stored in the opening part 6 against bias of the spring member 8 and once the tip 71a passes through the convex part 14, due to the bias of the spring member 8, it projects from the opening part 6. Therefore, after the insertion of the tubular supporting leg 5, the tip 71a of the projection member 7 is engaged with the convex part 14 to serve as a stopper that prevents the tubular supporting leg 5 from being unhinged. To pull out the tubular supporting leg 5 from the supporting hole manually, apply pull-out force that is a little stronger than the case where the convex part 14 is not provided so that the tip 71a can override the convex part 14.

The hinge member 3 is not limited to the one that stores the slider 11 and the spring member 12 in the tubular supporting leg as in the above-mentioned embodiment. Though not illustrated, a structure of the hinge member 3 in which the cam member 10 is fixed on the top end part of the tubular supporting leg 5 and the slider 11 and the spring member 12 are provided on the document pressing plate 2 side, or a conventionally known structure that is shown in FIG. 7 can be used.

What is claimed is:

1. An open/close device for a document pressing plate comprising:
a document pressing plate provided to an apparatus body via a hinge member to be able to open/close in a rotational manner, the hinge member provided on the edge side of a rotator of the document pressing plate and a tubular supporting leg that is inserted into a supporting hole provided on the upper surface of the apparatus body;
wherein an opening part is provided on a peripheral side wall of the tubular supporting leg, a projection member is incorporated into the tubular supporting leg so that the tip of the projection member can appear and disappear in the opening part while a spring member for pressing and biasing the projection member is also incorporated so that the projection member is always being pressed to allow the tip of the projection member being projected from the opening part, and the tip of the projection member that is projected from the opening is attached to the inner wall surface of the supporting hole.

2. The opening/closing device for a document pressing plate according to claim 1, wherein the hinge member that includes a cam member pivotally connected to the head side of the tubular supporting leg to be able to rotate with a hinge pin as its pivot point, a slider that is stored in the upper part of the projection member and the spring member in the tubular supporting leg that can freely slide and has a sliding projection that slides along a cam surface of the cam member, and a spring member for biasing the slider that always pushes and biases the slider toward the cam member, wherein the cam member, the slider, and the spring member for biasing the slider generate a torque which reacts to the direction of the torque to which the document pressing plate is closed to stop and keep the document pressing plate at a desired opening angle by the balance of the torque.
